(19) United States
(12) Patent Application Publication
(10) Pub. No.: US 2007/0156770 A1
(43) Pub. Date: Jul. 5, 2007

(54) System and method for controlling and/or managing metadata of multimedia

(76) Inventor: Joel Espelien, San Diego, CA (US)

Correspondence Address: PATENTS+TMS, P.C., 2849 W. ARMITAGE AVE., CHICAGO, IL, 60647, US

(21) Appl. No.: 11/581,526

(22) Filed: Oct. 16, 2006

Related U.S. Application Data
(60) Provisional application No. 60/727,911, filed on Oct. 18, 2005.

(51) Int. Cl. G06F 17/30

(52) U.S. Cl. 707/200

(57) ABSTRACT

A system and a method control and/or manage metadata of multimedia. The metadata is information and/or is data relating to, based on and/or associated with the multimedia. The metadata of the multimedia is accessed, is identified and/or is transferred to one or more terminals independently with respect to the multimedia, a content service associated with the multimedia and/or a media store. The system and the method organize, control and/or manage one or more subscriptions to one or more content services and/or media stores. The system and the method change between one or more content services and/or one or more media stores to transfer the metadata to and/or from one or more users and/or a source independently and/or separately from the multimedia. The system and the method procures, obtains, accesses and shares the metadata with the multimedia, the content service, the one or more users, the source and/or a provider. As a result, the metadata of the multimedia is portable with respect to one or more users, one or more terminals, the source, the provider and/or the content service. The users share, transfer, transmit and/or access the metadata via databases, terminals, servers and/or networks independent and/or separately with respect to the multimedia.

This application claims the benefit of U.S. Provisional Application Ser. No.: 60/727,911, filed Oct. 18, 2005.

### BACKGROUND OF THE INVENTION

The present invention generally relates to a system and a method for controlling and/or managing metadata of multimedia. More specifically, the present invention relates to a system and a method for controlling and/or managing metadata of multimedia content and/or multimedia files. One or more users may build, may manage, may control and/or may maintain a database of the multimedia content and/or the multimedia files via information based on and/or associated with the metadata. The multimedia content and/or the multimedia files may be consumed, may be accessed and/or may be viewed by one or more users via terminals over a first network. The multimedia content and/or the multimedia files may be consumed, may be obtained, may be accessed and/or may be displayed from one or more content services and/or one or more media stores via the terminals over the first network. The information of the metadata may be transferred, may be transmitted, may be received and/or may be accessed by a source which may be remote with respect to one or more users over the first network and/or a second network. One or more users and/or the source may procure, may obtain and/or may access the multimedia content and/or the multimedia files over the first network via a search, a request for proposal, an auction, a consultation and/or the like.

It is generally known, for example, that a user may download, may display, may access, may obtain and/or may view media content from a database and/or a content service via a terminal over a network. Typically, the user may execute an application of the terminal to locate, to identify and/or to search for the media content in the database and/or the content service. The application may be a desktop search engine, a music jukebox application, a compact disk database (hereinafter “CDDB”) and/or the like. The desktop search engine creates a searchable index of media files which are searchable by the user. However, the desktop search engine only searches media files which have been indexed during and/or before the user conducts a search via the desktop search engine. Further, the desktop search engine is incapable of searching and/or indexing media files and/or multimedia content which may be streamed, may be protected via encryption, may be purged by content rules associated with the database and/or the content service and/or may be a known but yet-to-be broadcasted media file by a network and/or the content service. Moreover, the desktop search engine may be incapable of tracking a usage of a media files by a user. Furthermore, the desktop search engine may not be application aware. As a result, the user may be required to provide information to the desktop search engine prior to searching for the media file.

The music jukebox application may be application aware and may track the usage of the media file. However, the music jukebox application may be limited to, may search and/or may track a single type of media file based on a format of the media file, the content service containing the media file and/or a content store providing the media file. For example, the user may not be capable of moving between more than one content service and/or one or more media stores without losing benefits and/or an intelligence of the music jukebox application. Further, metadata associated with the media file may only be identified and/or may only be accessed by a music jukebox application from a single content service and/or from a single content store. As a result, the music jukebox application and/or the terminal may not have intelligence and/or information associated with the media file relating to how and/or when the media file may have been acquired, may have been accessed, may have been transmitted and/or may have been consumed.

The CCDB application may be application aware and/or may associate the media file with an entry in a database for supplementing, modifying and/or revising the metadata of the media file. However, the CCDB does not track and/or does not identify a use of the metadata separate from the media file. As a result, the CCBD does not procure and/or does not obtain the metadata independently of the media files. Furthermore, the desktop search engine, the music jukebox application and/or the CCDB lack an ability for one or more users to share and/or to manage the metadata independently and/or separately from the media files to create a shared experience of the multimedia content.

A need, therefore, exists for a system and a method for controlling and/or managing metadata of multimedia. Further, a need exists for a system and a method for controlling and/or managing metadata of multimedia which may search and/or may index media files, media content and/or multimedia which may be streamed, may be protected by encryption, may be purged by content rules and/or may be a live broadcast by a media network, a content service and/or a media store. Still further, a need exists for a system and a method for controlling and/or managing metadata of multimedia which are application aware and/or may be capable of tracking and/or of monitoring a usage of a media file, a media content and/or multimedia. Moreover, a need exists for a system and a method for controlling and/or managing metadata of multimedia which may track, may manage and/or may monitor a usage of a media file, a media content and/or multimedia in one or more formats and/or provided by one or more content services and/or one or more media stores. Furthermore, a need exists for a system and a method for controlling and/or managing metadata of multimedia which may update, may revise, may obtain and/or may procure metadata associated with a media file, a media content and/or multimedia independently from the media file, the media content and/or the multimedia. Additionally, a need exists for a system and a method for controlling and/or managing metadata of multimedia which may allow one or more users to collaboratively manage, to transmit, to transfer and/or to share the metadata of the multimedia via a first network and/or a second network.

### SUMMARY OF THE INVENTION

The present invention generally relates to a system and a method for controlling and/or managing metadata of multimedia. The metadata may be information, a communication and/or data relating to, based on and/or associated with the multimedia. The metadata of the multimedia may be accessed, may be shared, may be identified and/or may be transferred to one or more terminals independently and/or separately with respect to the multimedia, a content service associated with the multimedia and/or with a media store providing the multimedia. As a result, the system may organize, may control and/or may manage one or more subscriptions to one or more content services, one or more media networks and/or one or more media stores. Further, the system may change and/or may switch between one or more content services and/or may transfer the metadata to and/or from users independently from the multimedia. The users may procure, may obtain, may share, may transfer and/or may access the metadata of the multimedia independently and/or separately from the content service and/or the media store via a first network and/or a second network. As a result, the metadata of the multimedia may be portable with respect to the multimedia, the content service, the media store and/or to the users.

In an embodiment of the present invention, a system for managing multimedia is provided. The system has a first database connected to a first communication network wherein a first digital media file is stored within the first database wherein the first digital media file has first metadata indicative of the first digital media file. Further, the first metadata has a first content tag which describes first information corresponding to the first digital media file wherein the first metadata is encoded in a first format. Still further, the system has a first terminal electrically connected to the first database via the first communication network wherein the first terminal has a second database wherein the first metadata of the first digital media file is stored within the second database. Moreover, the first terminal accesses the first metadata from the second database wherein the first terminal identifies the first digital media file via the first content tag wherein the first terminal identifies that the first digital media file is accessible over the first communication network from the first database via the first metadata. Furthermore, the system has a second terminal electrically connected to the first terminal wherein the second terminal is located remotely with respect to the first terminal wherein the second terminal accesses the first metadata which is stored within the second database of the first terminal wherein the second terminal identifies the first digital media file via the first content tag of the first metadata.

In an embodiment, the system has second metadata encoded in a second format wherein the first terminal converts the second metadata to the first format and stores the second metadata in the second database.

In an embodiment, the system has a second communication network connected to the first terminal wherein the first metadata stored within the second database is accessed via the second communication network.

In an embodiment, the system has a data store accessed by the first terminal wherein the first digital media file is accessed by the first terminal via the data store.

In an embodiment, the system has an electronic request for proposal transmitted from the first terminal to the first database wherein the first digital media file is identified by the first database from the request for proposal.

In an embodiment, the system has a third database located remotely with respect to the first database wherein the first terminal electrically connects to the third database and accesses the first digital media file.

In an embodiment, the first metadata has a second content tag with second information corresponding to the first digital media file wherein the second information is different information than the first information.

In an embodiment, the system has a media service accessed by the first terminal wherein the first metadata is transmitted from the media service to the first terminal via one of streaming, broadcasting and pushing.

In another embodiment of the present invention, a method for controlling metadata is provided. The method has the step of providing a server electrically connected to a first communication network wherein the server has a first database which stores a first digital media file wherein the first digital media file has first metadata indicative of the first digital media file wherein the first database of the server is accessible via the first communication network wherein the first metadata is encoded in a first format wherein the first digital media file is a type of media content. Further, the method has the step of providing a first terminal having a second database wherein the first terminal is electrically connected to a first communication network. Still further, the method has the step of transferring the first metadata of the first digital media file to the first terminal wherein the first terminal receives the first metadata separately from the first digital media file. Moreover, the method has the step of storing the first metadata within the second database of the first terminal wherein the first terminal accesses the first metadata and identifies the first digital media file from the first metadata.

In an embodiment, the method has the step of converting the first metadata to a second format wherein the second format is a different format than the first format.

In an embodiment, the method has the step of connecting a second terminal to the first terminal wherein the second terminal accesses the first metadata stored within the second database of the first terminal.

In an embodiment, the method has the step of subscribing to a content service wherein the first terminal procures the first digital media file via the content service.

In an embodiment, the method has the step of consuming the first digital media file wherein the first metadata is displayed independently from the first digital media file.

In an embodiment, the method has the step of tracking an amount of usage of the type of media content by the first terminal wherein the amount of usage of the type of media content is identified by the first metadata of the first digital media file.

In an embodiment, the method has the step of transmitting an electronic request for proposal to a plurality of content providers wherein the first digital media file is accessed from one of the plurality of content provider with the electronic request for proposal.

In an embodiment, the method has the step of preventing an amount of consumption of the type of media content wherein the first terminal identifies the amount of consumption of the type of media content by accessing the first metadata.

In another embodiment of the present invention, a method for managing multimedia is provided. The method has the step of providing a first terminal electrically connected to a first communication network wherein the first terminal has a first database wherein the first database stores first metadata and second metadata. Additionally, the first metadata is indicative of a first digital media file and the second metadata is indicative of a second digital media file wherein the first metadata and the second metadata are encoded in a first format wherein the first digital media file is a first type of media content wherein the second digital media file is a second type of media content wherein the first type of media content is a different type of media content than the second type of media content. Further, the method has the step of connecting a second database to the first communication network wherein the first digital media file is stored within the second database wherein the first terminal is in communication with the second database via the first communication network. Moreover, the method has the step of accessing the first metadata wherein the first terminal identifies the first digital media file from the first metadata and procures the first digital media file from the second database.

In an embodiment, the method has the step of storing the first digital media file in the first database of the first terminal wherein the first digital media file is consumable by the first terminal.

In an embodiment, the method has the step of connecting a second terminal to the first terminal wherein the first metadata and the second metadata stored within the first database of the first terminal are transmitted to the second terminal.

In an embodiment, the method has the step of assigning a content tag to the first metadata wherein the content tag is describes the first digital media file and the first type of media content of the first digital media file.

In an embodiment, the method has the step of displaying the first metadata on the first terminal wherein the first metadata is accessed independently from the first digital media file.

In an embodiment, the method has the step of converting the second metadata from a second format to the first format wherein the second format is a different format than the first format.

In an embodiment, the method has the step of storing a content list in the first database of the first terminal wherein the first metadata and the second metadata are displayed in the content list.

In an embodiment, the method has the step of receiving a transmission having the second digital media file wherein the first terminal identifies the second metadata of the second digital media file via the transmission.

In an embodiment, the method has the step of accessing a content provider via the first communication network wherein the second digital media file is procured from the content provider.

In an embodiment, the method has the step of accessing a data guide having third metadata indicative of the first digital media file wherein the first terminal reconciles the first metadata with the third metadata of the data guide.

In an embodiment, the method has the step of connecting a second communication network to the first terminal wherein the first metadata and the second metadata is accessible from the first database via the second communication network.

In an embodiment, the method has the step of tracking an amount of usage of the first type of media content by accessing the first metadata and the second metadata stored within the first database of the first terminal.

In an embodiment, the method has the step of blocking consumption of the first type of media content wherein the second type of media content is consumed by the first terminal.

It is, therefore, an advantage of the present invention to provide a system and a method for controlling and/or managing metadata of multimedia.

Another advantage of the present invention is to provide a system and a method for controlling and/or managing metadata of multimedia which may search and/or may index media files, media content and/or multimedia which may be streamed, may be protected by encryption, may be purged by content rules and/or may be a live broadcast by a network, a content service and/or a media store.

And, another advantage of the present invention is to provide a system and a method for controlling and/or managing metadata of multimedia which are application aware and/or may be capable of tracking and/or of monitoring a usage of a media file, media content and/or multimedia.

Yet another advantage of the present invention is to provide a system and a method for controlling and/or managing metadata of multimedia which may track, may manage and/or may monitor a usage of a media file, media content and/or multimedia in one or more formats and/or provided by one or more content services and/or one or more media stores.

A further advantage of the present invention is to provide a system and a method for controlling and/or managing metadata of multimedia which may update, may revise, may obtain and/or may procure metadata associated with a media file, media content and/or multimedia independently from the media file, the media content and/or the multimedia.

Moreover, an advantage of the present invention is to provide a system and a method for controlling and/or managing metadata of multimedia which may allow portability of the metadata and/or information associated with the metadata between one or more users and/or one or more terminals via a first network and/or a second network.

And, another advantage of the present invention is to provide a system and a method for controlling and/or managing metadata of multimedia which may organize the metadata of media files and/or the multimedia from subscriptions to content services and/or media stores.

Yet another advantage of the present invention is to provide a system and a method for controlling and/or managing metadata of multimedia which may switch and/or change between access to content services and/or media stores.

Another advantage of the present invention is to provide a system and a method for controlling and/or managing metadata of multimedia which may share and/or may receive the metadata of the multimedia between one or more users and/or a source unaffiliated with the multimedia.

Yet another advantage of the present invention is to provide a system and a method for controlling and/or managing metadata of multimedia which may procure multimedia via a request for proposal, an auction, a media consumption consultation and/or the like.

A still further advantage of the present invention is to provide a system and a method for controlling and/or managing metadata of multimedia which may provide an independent data store and/or a database to create, to update and to utilize the metadata of the multimedia.

Moreover, an advantage of the present invention is to provide a system and a method for controlling and/or managing metadata of multimedia which may provide a standard data format of the metadata, a mandatory content tag in the metadata and/or an optional content tag in the metadata.

And, another advantage of the present invention is to provide a system and a method for controlling and/or managing metadata of multimedia which may independently and/or separately display the metadata during consumption of and/or access of the multimedia.

Yet another advantage of the present invention is to provide a system and a method for controlling and/or managing metadata of multimedia which may display the metadata in a section on a screen, in a static form on the screen and/or in a scrolling text on the screen.

Moreover, an advantage of the present invention is to provide a system and a method for controlling and/or managing metadata of multimedia which may obtain metadata from a broadcast and/or from a streaming video feed and/or may reconcile the metadata against a schedule, an out-of-band source and/or a guide associated with the metadata.

And, another advantage of the present invention is to provide a system and a method for controlling and/or managing metadata of multimedia which may monitor, may control, may identify and/or may manage consumption of the multimedia by one or more users.

Yet another advantage of the present invention is to provide a system and a method for controlling and/or managing metadata of multimedia which may allow one or more users to collaboratively manage, to transfer and/or to share the metadata of the multimedia via a first network and/or a second network.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of a system in an embodiment of the present invention.

### DETAILED DESCRIPTION OF THE PREFERRED EMBODIMENTS

The present invention relates to a system and a method for controlling and/or managing metadata of multimedia. More specifically, the present invention relates to a system and a method for controlling and managing metadata of multimedia which provides a database connectable to a terminal for accessing, for obtaining, for procuring and/or for updating the metadata. As a result, the metadata may be portable, may be separated from and/or may be independent with respect to the multimedia. The metadata may be accessed from, may be downloaded from and/or may be provided by one or more content services and/or one or more media stores via a first network and/or a second network. As a result, the system may monitor, may control, may manage and/or may share the metadata of the multimedia separately and/or independently with respect to the multimedia. A source and/or one or more users may access, may identify, may download, and/or may share the metadata which may be stored within the database connected to the terminal.

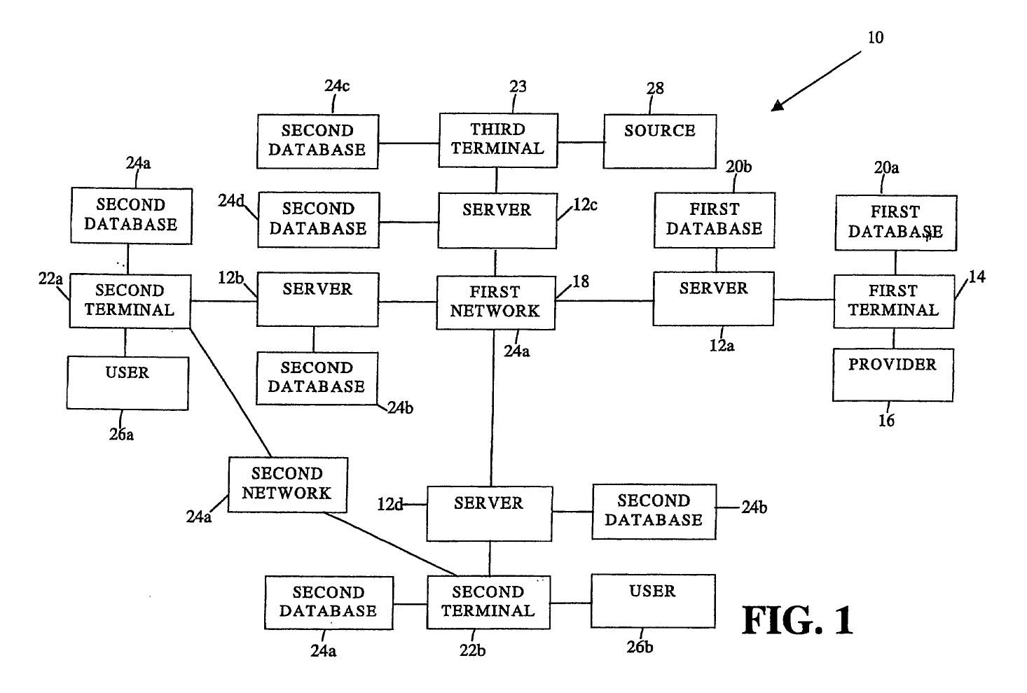

Referring now to the drawings wherein like numerals refer to like parts, FIG. 1 illustrates a system 10 which may have a server 12a for connecting a first terminal 14 of a provider 16 to a first data communication network 18 (hereinafter “the first network 18”). The first terminal 14 may be connected to and/or may be in communication with the server 12a. First databases 20a, 20b of the provider 16 may be connected to and/or may be accessible by the first terminal 14 and/or the server 12a, respectively. As a result, the first databases 20a, 20b may be connected to the first network 18. The first terminal 14 may be local and/or may be remote with respect to the server 12a and/or the first database 20a. The first database 20b may be local or may be remote with respect to the server 12a. The provider 16 may be, for example, a content service, a media store and/or the like. The provider 16 may access the first databases 20a, 20b and/or the first network 18 via the first terminal 14. The present invention should not be limited to a specific embodiment of the provider 16. It should be understood that the provider 16 may be any provider as known to one of ordinary skill in the art.

The first databases 20a, 20b may have, may contain and/or may store multimedia and/or data. The data may be, for example, audio signals, video frames, data streams and/or the like. The multimedia may be a digital media file, such as, for example, a musical composition, a radio program, an audio book, an audio program, a television program, a movie, a music video, an animated work, a video program, a video game and/or a soundtrack and/or a video track of an audiovisual work, a dramatic work, a film score and/or an opera and/or the like. Further, the data may be based on, may correspond to and/or may be associated with the media item. The present invention should not be limited to a specific embodiment of the data and/or the digital media file. It should be understood that the data and/or the digital media file may be any digital media file as known to one of ordinary skill in the art.

Metadata may be stored in, may be accessed from and/or may be contained in the first databases 20a, 20b of the provider 16. The metadata may have a communication, a first content tag and/or a second content tag. The first content tag and/or the second content tag may be, for example, a mandatory content tag and/or an optional content tag, respectively. The communication may be, for example, a comment, a note, a review, a correspondence, a message, a discussion, a notice, a bulletin, a memorandum, news and/or the like which may be related to, may be associated with and/or may be based on the multimedia and/or the digital media file. The first content tag and/or the second content tag may be information which may be related to, may be associated with, may be based on and/or may correspond to the multimedia and/or the digital media file. The information of the first content tag may be, for example, a name of the digital media file, a type of digital media file and/or the like. The type of digital media file may be, for example, a musical composition, a radio program, an audio book, an audio program, a television program, a movie, a music video, an animated work, a video program, a video game and/or a soundtrack and/or a video track of an audiovisual work, a dramatic work, a film score and/or an opera and/or the like. The present invention should not be limited to a specific embodiment of the information of the first content tag and/or the type of digital media file and/or a specific embodiment of the communication. It should be understood that the communication and/or the information of the first content tag may be any communication and/or information as known to one of ordinary skill in the art.

The information of the second content tag may be, for example, a year of the digital media file, an artist associated with the digital media file, a publisher or a copyright owner of the digital media file, a genre associated with the digital media file, a length of time of the digital media file. The information of the second content tag may be, for example, a content rating of the digital media file, a language associated with the digital media file, a key word associated with the digital media file, a review of the digital media file, a source of the digital media file and/or the like. The source of the digital media file may be, for example, an electronic address system, a reference to a content service or a content provider and/or the like. The present invention should not be limited to a specific embodiment of the information of the second content tag and/or the source of the digital media file. It should be understood that the information of the second content tag may be any information as known by one of ordinary skill in the art.

A server 12b may connect second terminals 22a, 22b to the first network 18. The second terminals 22a, 22b of users 26a, 26b may be in communication with the server 12b, 12d, respectively. Second databases 24a, 24b may be connected to and/or may be accessible by the second terminals 22a, 22b and/or the server 12b, 12d, respectively. As a result, the second databases 24a, 24b may be connected to the first network 18. The users 26a, 26b may access the first network 18 via the second terminals 22a, 22b and/or the servers 12b, 12d, respectively. The users 26a, 26b may access the second databases 24a, 24b via the second terminals 22a, 22b, respectively, and/or the servers 12b, 12d, respectively. The second terminals 22a, 22b may be local or may be remote with respect to the servers 12b, 12d and/or the second database 24a. The second database 24b may be local or may be remote with respect to the servers 12b. The users 26a, 26b may access the second databases 24a, 24b and/or the first network 18 via the second terminals 22a, 22b, respectively, and/or the servers 12b, 12d, respectively.

A server 12c may connect a third terminal 23 to the first network 18. The third terminal 23 of a source 28 may be in communication with the server 12c. The second databases 24c, 24d may be connected to and/or may be accessible by the third terminal 23 and/or the server 12c, respectively. As a result, the second databases 24c, 24d may be connected to the first network 18. The source 28 may access the first network 18 via the third terminal 23 and/or the server 12c. The source 28 may access the databases 24c, 24d via the third terminal 23 and/or the server 12c, respectively. The third terminal 23 may be local or may be remote with respect to the server 12c and/or the second database 24c. The second database 24d may be local or may be remote with respect to the server 12c. The source 28 may access the second databases 24c, 24d and/or the first network 18 via the third terminal 23 and/or the server 12c.

The second terminals 22a, 22b and/or the third terminal 23 may access, may download and/or may receive the multimedia and/or the metadata stored in the first databases 20a, 20b via the first network 18, the server 12a, the server 12b, the server 12c and/or the server 12d. The second terminals 22a, 22b may store, may create, may maintain and/or may update the multimedia and/or the metadata in the second databases 24a, 24b and/or the second databases 24c, 24d, respectively, via the servers 12b, 12d and/or the server 12c, respectively. As a result, the users 26a, 26b and/or the source 28 may access, may display, may view and/or may transmit the multimedia and/or the metadata via the second terminals 22a, 22b. The multimedia and/or the metadata may be transferred, may be transmitted, may be shared and/or may be exchanged between the second terminal 22a and the second terminal 22b via the first network 18 and/or the servers 12b, 12d. The users 26a, 26b may store and/or may access the multimedia and/or the metadata received from the second databases 24c, 24d in the second databases 24a, 24b via the servers 12b, 12d, the first network 18 and/or the second terminal 22a. The source 28 may store and/or may access the multimedia and/or the metadata received from the second databases 24a, 24b in the second databases 24c, 24d via the servers 12b, 12c, the first network 18 and/or the second terminal 22b.

The second terminals 22a, 22b and/or the third terminal 23 may be, for example, a computer terminal, a mobile device, a set-top box, a removable storage device and/or an electronic device which may be capable of transmitting, of receiving, of processing, of accepting and/or of displaying the multimedia and/or the metadata related to the multimedia. The set-top box may be connected to a display (not shown in the figure) for viewing and/or for displaying the multimedia and/or the metadata. The removable storage device may be capable of processing and/or executing software instructions for viewing and/or for displaying the multimedia or the metadata. Further, the mobile device may be, for example, a 3G mobile device, an internet protocol (hereinafter “IP”) video cellular telephone, a PDA, a laptop computer, mobile cellular telephone, a satellite radio receiver, a portable digital audio player, a portable digital video player and/or the like. It should be understood that the terminals 22a, 22b, 23 may be any terminal capable of transmitting, capable of receiving, capable of processing and/or capable of displaying the first data and/or the second data known to one having ordinary skill in the art.

The first network 18 may be, for example, an IP network, a wireless network, a wireline network, a local-area network, a wide-area network and/or the like. The second terminals 22a, 22b and/or the third terminal 23 may be remote with respect to and/or may be remotely connected to the server 12a, 12d and/or the server 12c, respectively, via the first network 18. The present invention should not be limited to a specific embodiment of the first network 18. It should be understood that the first network 18 may be any network capable of connecting and/or providing communication between the second terminals 22a, 22b and/or the third terminal 23 and the servers 12a, 12d and/or the server 24c, respectively, as known to one having ordinary skill in the art.

The second terminals 22a, 22b and/or the third terminal 23 may be connected to and/or may be in communication with the first terminal 14 via the servers 12a-12d and/or the first network 18. The servers 12a, 12d may stream, may transfer and/or may transmit the multimedia and/or the metadata to the second terminal 22a, 22d and/or the third terminal 23 via the first network 18 and/or the servers 12b, 12c, 12d. The multimedia and/or the metadata may be rendered, may be displayed and/or may reproduced to the users 26a, 26b and/or the source 28 via second terminals 22a, 22b, respectively.

The second terminal 22a may be connected to and/or may be in communication with the second terminal 22b via a second data communication network 50 (hereinafter “the second network 50”). The second terminals 22a, 22b may share, may transfer and/or may transmit the metadata via the second network 50. As a result, the metadata may be rendered, may be displayed and/or may reproduced to the users 26a, 26b via second terminals 22a, 22b, respectively over the second network 50. The metadata may be stored in the second databases 24a, 24b of the second terminals 22a, 22b, respectively. For example, the user 26b may access, may receive and/or may view the metadata of the user 26a via the second terminal 22b over the second network 50.

The second network 50 may be a peer-to-peer network, such as, for example, an IP network, a wireless network, a wireline network, a personal area network, a local-area network, a metropolitan area network, a wide-area network, a paging network, a public switched telephone network and/or the like. The second terminal 22a may be remote with respect to and/or may be remotely connected to the second terminal 22b via the second network 50. The present invention should not be limited to a specific embodiment of the second network 50. It should be understood that the second network 50 may be any network capable of connecting and/or providing communication between the second terminals 22a, 22b as known to one having ordinary skill in the art.

The second terminals 22a, 22b of the users 26a, 26b may access the first content tag and/or the second content tag of the multimedia in the first database 20a and/or the first database 20b via the servers 12a, 12d and/or the first network 18 and/or the second network 50. The second terminals 22a, 22b may process, may store, may manage and/or may access the information of the first content tag and/or the second content tag in the first database 20a and/or in the first database 20b separately from and/or independently with respect to the multimedia and/or the digital media file associated with the metadata. The second terminals 22a, 22b may be created, may be updated, may be obtained and/or may procure the metadata based on the first content tag and/or the second content tag of the multimedia. The second terminals 22a, 22b may store the metadata in the second database 24a and/or the second database 24b without an involvement and/or without an action by the provider 16 and the users 26a, 26b. As a result, the system 10 may store, may manage and/or may control a purchasing, a consumption and/or a usage of the multimedia by the users 26a, 26b based on the metadata stored in the second databases 24a, 24b.

The second terminals 22a, 22b may create and/or may store a content list in one of the second databases 24a, 24b. The content list may have and/or may be based on the metadata and/or may be formatted in a standard data format, such as, for example, XML, RDF, RSS, MathML, XHTML, SVG, cXML and/or the like. The second terminals 22a, 22b may identify, may log, may manage and/or may record a subscription of the users 26a, 26b to a content service providing the multimedia in the content list via the metadata of the multimedia. The content list may contain, may store, may track, may record and/or may log the metadata of the multimedia which may be accessed and/or may be received by the second terminals 24a, 24b. The content list may have content information related to and/or based on a date of access for, a location of access for, a content service associated with and/or a playlist associated with the multimedia and/or the metadata.

The metadata and/or the content information of the content list may be stored in one or more of the second databases 24a, 24b without accessing, without storing and/or without receiving the multimedia and/or the digital media file by the second terminals 22a, 22b and/or the second databases 24a, 24b. As a result, the content list, the content information and/or the metadata may be stored in the second database 24a and/or the second database 24b in the standard data format without the multimedia and/or the digital media file. The present invention should not be limited to a specific embodiment of the standard data format of the list and/or the metadata. It should be understood that the standard data format may be any computer mark up language as known by one having ordinary skill in the art.

The multimedia and/or the digital media file may be accessed by, may be transferred to, may be downloaded to and/or may be transmitted to the second terminals 22a, 22b via the servers 12a, 12d and/or the first network 18. The second terminals 22a, 22b may process, may map, may store and/or may convert the metadata which may be received with the multimedia and/or the digital media file to a standard data format corresponding to the standard data format of the content list. The provider 16 of the multimedia may limit and/or may control a usage of the multimedia by a restriction, such as, for example, a contract, an assertion of a copyright and/or a legal right which may be associated with and/or may be contained within the metadata. The second terminals 22a, 22b may process, may identify and/or may access the restriction of the metadata. The second terminals 22a, 22b may create and/or may store restriction information in the content list which may be stored in the second databases 24a, 24b based on the restriction of the metadata for the multimedia. As a result, the content list, the content information and/or the metadata may restrict, may control and/or may manage the usage of the multimedia by the users 26a, 26b based on the restriction information of the content list in the second database 24a and/or the second database 24b. Furthermore, the metadata may have and/or may contain third party information which may be associated with and/or may be based on a third party entity, such as, for example, an internet database of an advertising entity, a marketing entity and/or the like. The present invention should not be limited to a specific embodiment of the third party entity.

The second terminals 22a, 22b may display the metadata, the content list and/or the content information to the users 26a, 26b via an output device (not shown in the figure). The metadata, the content list and/or the content information may be displayed to the users 26a, 26b as the second terminals 22a, 22b may be consuming, may be accessing and/or may be processing the multimedia from the provider 16. The second terminals 22a, 22b may access, may process and/or may display the metadata, the content list and/or the content information which may be stored in the second database 24a and/or the second database 24b at any time of a playback of multimedia by the second terminals 22a, 22b. The second terminals 22a, 22b may display the metadata, the content list and/or the content information on the output device in a display form, such as, for example, a transparent overlay on top of multimedia, a static text in a particular section or area of the output means, a vertical scrolling text on the output means, a horizontal scrolling text on the output means and/or the like. It should be understood that the display form may be any display form as known by one of ordinary skill in the art.

In an embodiment of the present invention, a memory card (not shown in the figures) having and/or storing the multimedia and/or the metadata associated with the multimedia may be connected to and/or may be in communication with the second terminals 22a, 22b. The second terminals 22a, 22b may identify, may access and/or may process the multimedia and/or the metadata of the multimedia from the memory card. The memory card may be transferred between the users 26a, 26b and/or may be connectable to the second terminals 22a, 22b, respectively. As a result, the metadata of the memory card may be shared between, may be transferred between and/or may be accessed by the second terminals 22a, 22b. The memory card may be, for example, a solid-state electronic flash memory data storage device, a flash memory card, a memory stick, a SIM card, a smart card and/or a disk memory cards. The present invention should not be limited to a specific embodiment of the memory card. It should be understood that the memory card may be any memory device as known to one of ordinary skill in the art.

The second terminals 22a, 22b may create and/or may store the content list and/or the content information in one of the second databases 24a, 24b based on the metadata of the multimedia from the memory card. The second terminals 22a, 22b may identify and/or may communicate with the provider 16 which may be associated with the multimedia of the memory card based on the metadata from the memory card. The second terminals 22a, 22b may access and/or may communicate with the first databases 20a, 20b to update, to obtain and/or to procure the metadata of the memory card, the content list and/or the content information based on the metadata associated with the multimedia in the first databases 20a, 20b. The second terminals 22a, 22b may store and/or may access the metadata, the content list and/or the content information based on the metadata from the first databases 20a, 20b and/or the memory card. As a result, the metadata, the content list and/or the content information may be stored in the second databases 24a, 24b without storing the multimedia in the second databases 24a, 24b.

The users 26a, 26b may terminate a right to and/or a capability to access, to display and/or to consume the multimedia. An expiration or a cancellation of a subscription contract for the multimedia may terminate the right of the users 26a, 26b to access, to display and/or to consume the multimedia. Alternatively, the users 26a, 26b may exhaust the right to and/or the capability to access, to display and/or to consume the multimedia based on a purchase agreement between the users 26a, 26b and the provider 16. As a result, the multimedia may be locked and/or may be unplayable by the second terminals 22a, 22b. The metadata, the content list and/or the content information associated with and/or based on the multimedia may be maintained in and/or may be stored in the second databases 24a, 24b with the multimedia being unavailable to the users 26a, 26b.

The users 26a, 26b may access, may receive and/or may consume a live broadcast of multimedia from the provider 16 over the first network 18. The live broadcast may be, for example, a radio-style music service, a TV-style video service and/or the like. The users 26a, 26b may be passively receiving a live feed and/or may not be capable of identifying the multimedia of the live broadcast. Further, the users 26a, 26b may not have a record, a log and/or a list of the multimedia which may be accessed, may be received and/or may be consumed during the live broadcast. The present invention should not be limited to a specific embodiment of the live broadcast. It should be understood that the live broadcast may be any live broadcast over the first network 18 as known to one of ordinary skill in the art.

The second terminals 22a, 22b may identify, may access and/or may process the metadata associated with the multimedia of the live broadcast. The second terminal 22a may create and/or may store the content list and/or content information in the second databases 24a, 24b based on the metadata from the live broadcast. The metadata, the content list and/or the content information may be stored in the second databases 24a, 24b without storing the multimedia from the live broadcast in the second databases 24a, 24b. As a result, the users 26a, 26b may identify the multimedia from the live broadcast based on a replication of the metadata, the content list and/or the content information from the second databases 24a, 24b via the second terminals 22a, 22b. Moreover, the second terminals 22a, 22b may reconcile the metadata, the content list and/or the content information against an out-of-band data guide, such as, for example, a television guide which may provide information about a schedule of the live broadcast to identify the multimedia. The present invention should not be limited to a specific embodiment of the out-of-band data guide. It should be understood that the live broadcast and/or the out-of-band data guide may be any data guide as known to one of ordinary skill in the art.

The users 26a, 26b may search the first databases 20a, 20b and/or the second databases 24a-24d to identify, to access, to download and/or to consume the multimedia via the second terminals 22a, 22b. The metadata, the content list and/or the content information in the second databases 24a, 24b may identify the multimedia to which the users 26a, 26b may have access, may have downloaded and/or may have consumed. As a result, the users 26a, 26b may search the first databases 20a, 20b and/or the second databases 24c, 24d based on the metadata, the content list and/or the content information in the second databases 24a, 24b.

The users 26a, 26b may re-consume the multimedia which may have been accessed, may have been displayed and/or may have been consumed by the users 26a, 26b. The metadata, the content list and/or the content information in the second databases 24a, 24b may be a record of the multimedia which may have been accessed and/or may have been consumed by the users 26a, 26b. The second terminals 22a, 22b may locate, may access, may display and/or may consume the multimedia which may be stored locally in second databases 24a, 24b. The users 26a, 26b may be required to have the right to consume the multimedia prior to accessing and/or to displaying the multimedia which may be stored in the second databases 24a, 24b. The second terminals 22a, 22b may locate, may access, may display and/or may consume the multimedia which may be stored remotely in the second databases 24c, 24d of the source 28 and/or the first databases 20a, 20b of the provider 16. The users 26a, 26b may be required to have the right to consume the multimedia prior to accessing and/or to displaying the multimedia which may be stored in the second databases 24c, 24d and/or the first databases 20a, 20b. The second terminals 22a, 22b may locate the provider 16 of the live broadcast to access, to display and/or to consume the multimedia from the live broadcast. The users 26a, 26b may be required to subscribe and/or to maintain a subscription with the provider 16 prior to accessing and/or to displaying the multimedia from the live broadcast.

The second terminals 22a, 22b may transmit, may send, may transfer and/or may issue an electronic request for proposal (hereinafter “RFP”) on behalf of the users 26a, 26b, respectively, to the provider 16 and/or the source 28. The electronic RFP may request that the provider 16 and/or the source 28 provide a quote on the right to access, to display and/or to consume the multimedia identified by the users 26a, 26b. The provider 16 and/or the source 28 may provide the quote to the users 26a, 26b for the right to provide the multimedia to the users 26a, 26b based on the electronic RFP requested by the users 26a, 26b. For example, the second terminals 22a, 22b may transmit, may send, may transfer and/or may issue an electronic RFP for the user 26a, 26b to the provider 16 and/or the source 28 for a license to consume a collection of disco music for a duration of time, such as, for example, two hours. The provider 16 and the source 28 may send, may transmit and/or may issue the quote to the user for the license based on the electronic RFP. The users 26a, 26b may select to purchase the license from the provider 16 or the source 28 based on the quote by the provider 16 or the source 28, respectively.

The source 28 may request and/or may seek advice regarding the multimedia. The users 26a, 26b may share, may transfer and/or may send the metadata, the content list and/or the content information stored within the second databases 24a, 24b for providing advice or recommendations regarding the multimedia to the source 28. The users 26a, 26b and/or the source 28 may request the advice and/or the recommendations based on a past consumption of the multimedia by the users 26a, 26b. The users 26a, 26b and/or the source 28 may access, may review and/or may process the metadata, the content list and/or the content information of the users 26a, 26b to identify the advice and/or the recommendations of the users 26a, 26b regarding the multimedia. As a result, the source 28 may receive the advice and/or the recommendations from the users 26a, 26b and/or the source 28 which may be independent with respect to the provider 16 and/or an entity associated with the multimedia.

The users 26a, 26b may access, may identify, may process and/or may download metadata for multimedia which may be stored in the second databases 24a-24d. As a result, the users 26a, 26b may acquire and/or may store the metadata from the second databases 24c, 24d to populate the second databases 24a, 24b with the metadata of the multimedia from the source 28. The users 26a, 26b may obtain, may procure and/or may create the content list and/or the content information based on the metadata of the multimedia from the second databases 24a-24d. For example, the users 26a, 26b may acquire, may obtain and/or may create a list of songs by an artist, a list of episodes of a television program and/or movies made by an actor. The content list may be stored in the second databases 24a, 24b by the users 26a, 26b.

In an embodiment of the present invention, the source 28 may be a professional source, such as, for example, a record label, a television network, a movie studio, an entity associated with an interest of the users 26a, 26b and/or the like. The source 28 may develop a specialized list of multimedia which may be unique, idiosyncratic and/or may be related to the interest of the users 26a, 26b. For example, a source 28 may publish and/or may store a list of movies with a common cinematographer and/or a common producer in the second databases 24c, 24d. The present invention should not be limited to a specific embodiment of the source and/or the professional source. It should be understood that the source and/or the professional source may be any source and/or any professional source as known to one of ordinary skill in the art.

The users 26a, 26b may interface and/or may communicate with the provider 16 and/or the source 28 via the metadata, the content list and/or the content information which may be stored in the first databases 20a, 20b and/or the second databases 24a-24d. The users 26a, 26b may receive the metadata from the provider 16 via a program guide, such as, for example, an electronic program guide, an interactive program guide and/or the like. Alternatively, the provider 16 may transmit and/or may send a program guide to the users 26a, 26b in response to a query to a website of the provider 16 and/or to a website of the source 28. The provider 16 may identify the multimedia related to the metadata of the multimedia and the query. The second terminals 22a, 22b may determine whether the multimedia may match and/or may correspond to the query based on the metadata of the multimedia. If the multimedia may match the query, the second terminal 22a may procure access to the multimedia and may request a transmission of the multimedia via broadcasting, streaming and/or downloading.

The users 26a, 26b may receive a periodic update of the metadata, the content list and/or the content information in the second database 24a, 24b. The periodic update may transmit and/or may transfer metadata associated with multimedia which the users 26a, 26b may wish and/or may desire to consume to the second databases 24a, 24b via the second terminal 22a. The periodic update may have, for example, a recommendation by a professional reviewer and/or a professional editor regarding a quality of the multimedia. Further, the periodic update may have, for example, a recommendation as to a multimedia most suitable for an audience and/or a recommendation as to a multimedia involving an artist and/or a performer. Still further, the periodic update may have, for example, a recommendation based on interests or values of a first group, such as, for example, a family, a school, a religious group and/or a cultural group related to aspects of a content of the interests and/or the values of the first group. Moreover, the periodic update may have, for example, a recommendation based on a popularity and/or a suitability of the multimedia and/or a recommendation based on an affiliation with a second group, such as, for example, a demographic group, an age group, an ethnic group, a racial group, a geographic group and/or a gender group. The present invention should not be limited to a specific embodiment of the first group and/or the second group. It should be understood that the periodic update may have any information and/or any recommendation as known to one of ordinary skill in the art.

The provider 16 and/or the source 28 may provide, may transmit and/or may maintain a “media diet” which may have a recommended amount of a type of multimedia content for the users 26a, 26b via the first network 18. The users 26a, 26b may subscribe to the media diet of the provider 26 and/or the source 28. The media diet may recommend and/or may advise the users 26a, 26b to consume and/or to avoid consuming amounts of types of multimedia during a time period, such as, for example, twelve hours, a day, a week, a month and/or the like. The second terminals 22a, 22b may process the metadata, the content list and/or the content information in the second databases 24a, 24b to determine whether the users 26a, 26b may be fulfilling, may be maintaining and/or may be exceeding the media diet. The second terminals 22a, 22b may maintain and/or may comply with the media diet by tracking multimedia consumption by the users 26a, 26b via the metadata, the content list and/or the content information. For example, the media diet and/or the second terminals 22a, 22b may track and/or may measure the amount of the type of multimedia consumed by the users 26a, 26b, such as, for example, pornographic multimedia for adults, violent multimedia, celebrity gossip multimedia, cartoon media for children, sports, news and/or the like. It should be understood that the type of multimedia of the media diet may be any multimedia as known to one of ordinary skill in the art.

The media diet of the users 26a, 26b may be passive, semi-active or active. A passive media diet may remind the users 26a, 26b of the media diet recommendation and/or the status of the media diet with respect to the multimedia consumed by the users 26a, 26b. A semi-active media diet may suggest multimedia options, such as, for example, viewing another type of multimedia to the users 26a, 26b which may comply with the recommendations of the media diet. An active media diet may block a type of multimedia after the recommendation of the media diet has been exceeded for that type of media.

In an embodiment of the present invention, the source 28 may obtain a report based on the multimedia consumed by the users 26a, 26b. The report may be created and/or may be based on the metadata, the content list and/or the content information in the second databases 24a, 24b of the users 26a, 26b. For example, the source 28 may be a parent which may monitor the multimedia consumed by a child of the parent. Further, the source 28 may be an employer which may monitor the multimedia consumed on employer-owned equipment. Still further, the source 28 may be monitoring the multimedia consumed by the user to maintain compliance with the media diet of the users 26a, 26b. Moreover, the source 28 may be an advertising firm and/or a marketing firm which may access the metadata in the second databases 24a, 24b for a marketing transaction. As a result, the users 26a, 26b may determine and/or may decide to participate in a commercial transaction and/or the marketing transaction. The users 26a, 26b may participate to receive a renumeration from the source 28, such as, for example, subsidized access to the multimedia, a cash payment, an electronic payment, a credit or a coupon usable for multimedia, a good and/or a service, a prize and/or a consideration which may be related to, may be associated with and/or may be based on the source 28.

The system 10 may control and/or may manage the metadata of multimedia which may be accessed, may be displayed and/or may be consumed by the users 26a, 26b via the second terminals 22a, 22b. The system 10 may have the first database 20a, 20b which may be connectable to the second terminals 22a, 22b for accessing, for obtaining, for procuring and/or for updating the metadata via the first network 18. As a result, the metadata may be portable and/or may be independent with respect to the multimedia. The metadata may be accessed from, may be downloaded from, may be received from the provider 16 and/or the source 28 via the first network 18. As a result, the system 10 may monitor, may control, may manage and/or may share the metadata of the multimedia independently with respect to the multimedia. The users 26a, 26b and/or the source 28 may access, may identify, may download and/or may share the metadata which may be stored within the second database 24a-24d via the second terminals 22a, 22b and/or the third terminal 23.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for managing multimedia, the system comprising:
a first database connected to a first communication network wherein a first digital media file is stored within the first database wherein the first digital media file has first metadata indicative of the first digital media file wherein the first metadata has a first content tag which describes first information corresponding to the first digital media file wherein the first metadata is encoded in a first format;
a first terminal electrically connected to the first database via the first communication network wherein the first terminal has a second database wherein the first metadata of the first digital media file is stored within the second database wherein the first terminal accesses the first metadata from the second database wherein the first terminal identifies the first digital media file via the first content tag wherein the first terminal identifies that the first digital media file is accessible over the first communication network from the first database via the first metadata; and
a second terminal electrically connected to the first terminal wherein the second terminal is located remotely with respect to the first terminal wherein the second terminal accesses the first metadata which is stored within the second database of the first terminal wherein the second terminal identifies the first digital media file via the first content tag of the first metadata.

2. The system of claim 1 further comprising:
second metadata encoded in a second format wherein the first terminal converts the second metadata to the first format and stores the second metadata in the second database.

3. The system of claim 1 further comprising:
a second communication network connected to the first terminal wherein the first metadata stored within the second database is accessed via the second communication network.

4. The system of claim 1 further comprising:
a data store accessed by the first terminal wherein the first digital media file is accessed by the first terminal via the data store.

5. The system of claim 1 further comprising:
an electronic request for proposal transmitted from the first terminal to the first database wherein the first digital media file is identified by the first database from the request for proposal.

6. The system of claim 1 further comprising:
a third database located remotely with respect to the first database wherein the first terminal electrically connects to the third database and accesses the first digital media file.

7. The system of claim 1 wherein the first metadata has a second content tag with second information corresponding to the first digital media file wherein the second information is different information than the first information.

8. The system of claim 1 further comprising:
a media service accessed by the first terminal wherein the first metadata is transmitted from the media service to the first terminal via one of streaming, broadcasting and pushing.

9. A method for controlling metadata, the method comprising the steps of:
providing a server electrically connected to a first communication network wherein the server has a first database which stores a first digital media file wherein the first digital media file has first metadata indicative of the first digital media file wherein the first database of the server is accessible via the first communication network wherein the first metadata is encoded in a first format wherein the first digital media file is a type of media content;
providing a first terminal having a second database wherein the first terminal is electrically connected to a first communication network;
transferring the first metadata of the first digital media file to the first terminal wherein the first terminal receives the first metadata separately from the first digital media file; and
storing the first metadata within the second database of the first terminal wherein the first terminal accesses the first metadata and identifies the first digital media file from the first metadata.

10. The method of claim 10 further comprising the step of:
converting the first metadata to a second format wherein the second format is a different format than the first format.

11. The method of claim 10 further comprising the step of:
connecting a second terminal to the first terminal wherein the second terminal accesses the first metadata stored within the second database of the first terminal.

12. The method of claim 10 further comprising the step of:
subscribing to a content service wherein the first terminal procures the first digital media file via the content service.

13. The method of claim 10 further comprising the step of:
consuming the first digital media file wherein the first metadata is displayed independently from the first digital media file.

14. The method of claim 10 further comprising the step of:
tracking an amount of usage of the type of media content by the first terminal wherein the amount of usage of the type of media content is identified by the first metadata of the first digital media file.

15. The method of claim 10 further comprising the step of:
transmitting an electronic request for proposal to a plurality of content providers wherein the first digital media file is accessed from one of the plurality of content provider with the electronic request for proposal.

16. The method of claim 10 further comprising the step of:
preventing an amount of consumption of the type of media content wherein the first terminal identifies the amount of consumption of the type of media content by accessing the first metadata.

17. A method for managing multimedia, the method comprising the steps of:
providing a first terminal electrically connected to a first communication network wherein the first terminal has a first database wherein the first database stores first metadata and second metadata wherein the first metadata is indicative of a first digital media file and the second metadata is indicative of a second digital media file wherein the first metadata and the second metadata are encoded in a first format wherein the first digital media file is a first type of media content wherein the second digital media file is a second type of media content wherein the first type of media content is a different type of media content than the second type of media content;
connecting a second database to the first communication network wherein the first digital media file is stored within the second database wherein the first terminal is in communication with the second database via the first communication network; and
accessing the first metadata wherein the first terminal identifies the first digital media file from the first metadata and procures the first digital media file from the second database.

18. The method of claim 17 further comprising the step of:
storing the first digital media file in the first database of the first terminal wherein the first digital media file is consumable by the first terminal.

19. The method of claim 17 further comprising the step of:
connecting a second terminal to the first terminal wherein the first metadata and the second metadata stored within the first database of the first terminal are transmitted to the second terminal.

20. The method of claim 17 further comprising the step of:
assigning a content tag to the first metadata wherein the content tag is describes the first digital media file and the first type of media content of the first digital media file.

21. The method of claim 17 further comprising the step of:
displaying the first metadata on the first terminal wherein the first metadata is accessed independently from the first digital media file.

22. The method of claim 17 further comprising the step of:
converting the second metadata from a second format to the first format wherein the second format is a different format than the first format.

23. The method of claim 17 further comprising the step of:
storing a content list in the first database of the first terminal wherein the first metadata and the second metadata are displayed in the content list.

24. The method of claim 17 further comprising the step of:
receiving a transmission having the second digital media file wherein the first terminal identifies the second metadata of the second digital media file via the transmission.

25. The method of claim 17 further comprising the step of:
accessing a content provider via the first communication network wherein the second digital media file is procured from the content provider.

26. The method of claim 17 further comprising the step of:
accessing a data guide having third metadata indicative of the first digital media file wherein the first terminal reconciles the first metadata with the third metadata of the data guide.

27. The method of claim 17 further comprising the step of:
connecting a second communication network to the first terminal wherein the first metadata and the second metadata is accessible from the first database via the second communication network.

28. The method of claim 17 further comprising the step of:
tracking an amount of usage of the first type of media content by accessing the first metadata and the second metadata stored within the first database of the first terminal.

29. The method of claim 17 further comprising the step of:
blocking consumption of the first type of media content wherein the second type of media content is consumed by the first terminal.
